(19) United States
(12) Patent Application Publication
(10) Pub. No.: US 2026/0074812 A1
(43) Pub. Date: Mar. 12, 2026

(54) Electronic Devices with Wireless Communication Sharing

(71) Applicant: Apple Inc., Cupertino, CA (US)

(72) Inventors: Chang Zhang, San Jose, CA (US); Joshua L Daigle, Toronto (CA)

(21) Appl. No.: 19/320,499

(22) Filed: Sep. 5, 2025

Related U.S. Application Data
(60) Provisional application No. 63/692,520, filed on Sep. 9, 2024.

(51) Int. Cl. H04B 17/382; H04B 17/309

(52) U.S. Cl. CPC H04B 17/382; H04B 17/309

(57) ABSTRACT

A communications system may include a host device and an external display. A wired path may couple a first data port on the host device to a second data port on the external display. The host device may drive the external display to display images via the wired path. A first radio on the host device may generate first wireless performance metric data and a second radio on the external display may generate second wireless performance metric data. The external display may transmit the second wireless performance metric data to the host device over the wired path. The host device may switch between conveying wireless data using the first radio or the second radio based on the first and second wireless performance metric data.

This application claims the benefit of U.S. Provisional Patent Application No. 63/692,520, filed September 9, 2024, which is hereby incorporated by reference herein in its entirety.

### FIELD

This disclosure relates generally to wireless communications, including wireless communications performed by electronic devices.

### BACKGROUND

Communications systems can include electronic devices with radios that wirelessly communicate using radio-frequency signals. Two or more electronic devices can also be connected using a wired communications path.

Situations can arise in which a radio on one of the electronic devices exhibits insufficient performance in conveying wireless data with a wireless network. If care is not taken, this can be detrimental to a user’s experience with the electronic device

### SUMMARY

A communications system may include a host device and an external display. The host device may include a first radio, a first antenna, and a first wired data port. The external display may include a second radio, a second antenna, and a second wired data port. A wired communications path may couple the first data port to the second data port. The host device may transmit display data to the external display via the first and second data ports and the wired communications path. The external display may display the display data.

The first radio may generate first wireless performance metric data characterizing the wireless performance of the first radio. The second radio may generate second wireless performance metric data characterizing the wireless performance of the second radio. The external display may transmit the second wireless performance metric data to the host device via the first and second data ports and the wired communications paths. The host device may switch between conveying wireless data using the first radio or the second radio based on the first and second wireless performance metric data. For example, the host device may use the first radio and the first antenna to convey the wireless data when the first radio exhibits a higher level of wireless performance than the second radio. On the other hand, the host device may use the first and second data ports, the wired path, the second radio, and the second antenna to convey the wireless data when the second radio exhibits a higher level of wireless performance than the first radio.

An aspect of the disclosure provides an electronic device. The electronic device can include a radio. The electronic device can include an antenna communicatively coupled to the radio. The electronic device can include a data port configured to receive a cable. The electronic device can include processing circuitry configured to transmit display data to an external display device via the data port and the cable. The radio can be configured to use the antenna to transmit, at a first time, first wireless data to a wireless network in a first radio-frequency signal. The radio can be configured to transmit, at a second time, second wireless data to the wireless network via the data port, the cable, and a second radio-frequency signal conveyed between the external display device and the wireless network.

An aspect of the disclosure provides a method of operating a host device communicatively coupled to an external display over a wired path. The method can include driving, using a data port on the host device and the wired path, the external display to display images. The method can include generating, using a first radio on the host device, first wireless performance metric data associated with operation of the first radio. The method can include receiving, using the data port, second wireless performance metric data from the external display via the wired path, the second wireless performance metric data being associated with operation of a second radio external to the host device. The method can include selecting, based on the first and second wireless performance metric data, either the first radio or the second radio for use in conveying wireless data between the host device and a wireless network.

An aspect of the disclosure provides a method of operating a computer monitor. The method can include receiving, using a data port on the computer monitor, display data from a host device via a cable coupled between the host device and the data port. The method can include displaying the display data. The method can include receiving, using the data port, wireless data from the host device via the cable concurrent with receiving the display data. The method can include transmitting, using a radio and an antenna on the computer monitor, the wireless data to a wireless access point.

### BRIEF DESCRIPTION OF THE DRAWINGS

FIG. 1 is a schematic diagram of an illustrative communications system including two electronic devices that communicate with a wireless network in accordance with some embodiments.

FIG. 2 is a flow chart of illustrative operations involved in using two electronic devices to convey wireless data with a wireless network in accordance with some embodiments.

FIG. 3 is a flow chart of illustrative operations involved in conveying wireless data between a host device and a wireless network in accordance with some embodiments.

FIG. 4 is a perspective view showing one example in which a laptop computer conveys wireless data with a wireless network directly or via a wired communications path and an external display in accordance with some embodiments.

FIG. 5 is a diagram showing an illustrative example in which a peripheral device of an external display conveys wireless data for a host device in accordance with some embodiments.

FIG. 6 is a diagram showing an illustrative example in which a host device conveys wireless data with a wireless network directly, via an external display, and/or via an intervening device in accordance with some embodiments.

### DETAILED DESCRIPTION

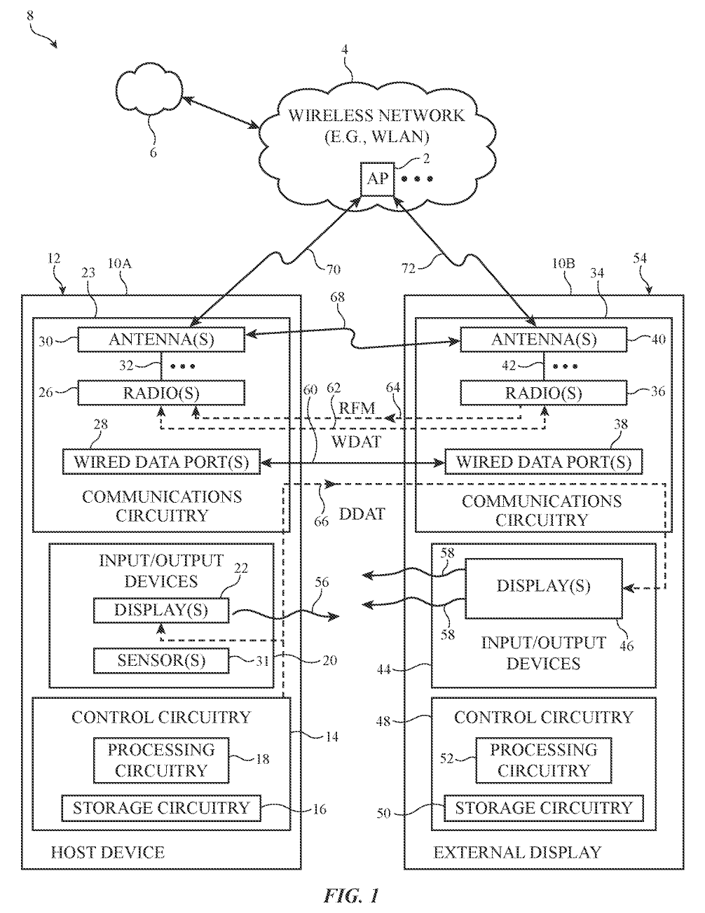

FIG. 1 is a diagram of an illustrative communications system 8. Communications system 8 (sometimes referred to herein as communications network 8, network 8, or system 8) includes a set of user equipment (UE) devices such as devices 10. Devices 10 may include at least a first device 10A and a second device 10B. Device 10A is sometimes referred to herein as host device 10A. Devices 10A and 10B may each be owned, operated, possessed, controlled, and/or otherwise associated with a corresponding user. Alternatively, devices 10A and 10B may be owned, operated, possessed, controlled, and/or otherwise associated with two different users.

Communications system 8 also includes a wireless network 4. Wireless network 4 may include wireless communications equipment that conveys radio-frequency signals. Wireless network 4 may be a wireless local area network (WLAN), a wireless personal area network (WPAN), a peer-to-peer (P2P) network, a device-to-device (D2D) network, or a cellular telephone network, for example. In implementations where wireless network 4 is a P2P network, a D2D network, or a WPAN, the wireless communications equipment in wireless network 4 may include one or more additional devices 10. In implementations where wireless network 4 is a cellular telephone network, the wireless communications equipment in wireless network 4 may include one or more wireless base stations (gNBs).

Implementations in which wireless network 4 is a WLAN are described herein as an example. The wireless communications equipment in the WLAN may include one or more wireless access points such as access point (AP) 2. AP 2 may include wireless circuitry such as baseband circuitry, one or more radios, and one or more antennas for conveying radio-frequency signals that carry wireless data. This is illustrative and non-limiting and, in general, wireless network 4 may be any desired type of wireless network and AP 2 may be replaced with any desired wireless communications equipment.

Wireless network 4 may be communicatively coupled to network 6 in communications system 8 (e.g., over one or more wired paths and/or wireless paths). AP 2 may wirelessly communicate with host device 10A and device 10B. AP 2 may communicatively couple host device 10A and device 10B to network 6 (e.g., may serve as a communications interface, switch, router, and/or relay between devices 10A/10B and network 6).

Network 6 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of network 6 may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of network 6 may include network switches, network routers, optical add-drop multiplexers, other multiplexers, repeaters, modems, portals, gateways, servers, network cards (line cards), wireless access points, wireless base stations, and/or any other desired network components. The network nodes in network 6 may include physical components such as electronic devices, servers, computers, network racks, line cards, user equipment, etc., and/or may include virtual components that are logically defined in software and that are distributed across (over) two or more underlying physical devices (e.g., in a cloud network configuration).

Host device 10A and device 10B may be any desired electronic devices. Device 10A and/or device 10B may be, for example, a laptop computer, a desktop computer, a computer monitor containing an embedded computer, a tablet computer, a cellular telephone, a media player, or other handheld or portable electronic device, a smaller device such as a wristwatch device, a pendant device, an accessory device such as wireless headphones, a wireless earbud/earpiece, gaming controller, or user input device (e.g., a mouse, keyboard, pointing device, etc.), a head-mounted device such as goggles, eyeglasses, a helmet, or other equipment worn on a user’s head (e.g., an augmented, virtual, or mixed reality head-mounted display device), or another wearable or miniature device, a television, a computer display device that does or does not contain an embedded computer, a gaming device (e.g., a video gaming console), a video streaming or playback device, a video transmitting device, a camera, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, equipment that implements the functionality of two or more of these devices, or other electronic equipment.

In some implementations that are described herein as an example, device 10B may be a wireless-enabled external display for one or more other devices 10 such as host device 10A. Device 10B is therefore sometimes also referred to herein as external display 10B. External display 10B may be a wireless-enabled computer monitor or a wireless-enabled television, as two examples. This is illustrative and non-limiting and, if desired, external display 10B may be replaced with any other desired type of wireless-enabled device 10. Host device 10A is sometimes also referred to herein as primary device 10A, driving device 10A, or host 10A. External display 10B is sometimes also referred to herein as secondary device 10B, driven device 10B, auxiliary device 10B, display device 10B, display 10B, external display device 10B, wireless-enabled display device 10, wireless-enabled display 10, wireless-enabled external display 10B, or wireless-enabled external display device 10B.

Host device 10A may include a housing such as housing 12. External display 10B may include a housing such as housing 54. Housings 12 and 54, which are sometimes also referred to as cases, may each be formed from plastic, glass, ceramics, fiber composites, metal (e.g., stainless steel, aluminum, titanium, etc.), other suitable materials, or a combination of these materials. In some situations, parts of housings 12 and/or 54 may be formed from dielectric or other low-conductivity material (e.g., glass, ceramic, plastic, sapphire, etc.). In other situations, housings 12 and/or 54 or at least some of the structures that make up housings 12 and/or 54 may be formed from metal elements.

Host device 10A may include control circuitry such as control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 14 may include processing circuitry such as processing circuitry 18. Processing circuitry 18 may be used to control the operation of host device 10A. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in host device 10A using hardware (e.g., dedicated hardware or circuitry), firmware, and/or software. Software code for performing operations in host device 10A may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

External display 10B may include control circuitry such as control circuitry 48. Control circuitry 48 may include storage such as storage circuitry 50. Storage circuitry 50 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 48 may include processing circuitry such as processing circuitry 52. Processing circuitry 52 may be used to control the operation of external display 10B. Processing circuitry 52 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in external display 10B using hardware (e.g., dedicated hardware or circuitry), firmware, and/or software. Software code for performing operations external display 10B may be stored on storage circuitry 50 (e.g., storage circuitry 50 may include non-transitory (tangible) computer readable storage media that stores the software code). Software code stored on storage circuitry 50 may be executed by processing circuitry 52.

If desired, control circuitry 48 of external display 10B may include fewer processing and/or storage resources than control circuitry 14 of host device 10A (e.g., control circuitry 14 may perform a wide range of electronic device functions for host device 10A whereas control circuitry 48 only needs to perform at least display operations and wireless communications operations for external display 10B). This may, for example, help to reduce the amount of power consumed by external display 10B and/or the cost of external display 10B.

Control circuitry 14 may be used to run software on host device 10A and control circuitry 48 may be used to run software on external display 10B. Software executed by control circuitry 14 on host device 10A may include, for example, internet browsing applications, voice-over-internet-protocol (VOIP) telephone call applications, messaging applications, social media applications, word processing applications, spreadsheet applications, office applications, productivity applications, email applications, media playback applications, gaming applications, virtual, augmented, or mixed reality applications, navigation or mapping applications, operating system functions, etc. Execution of one or more of these applications may involve the transmission of wireless data to an end host via wireless network 4 and/or the reception of wireless data from the end host via wireless network 4. The end host may be another device 10, a content delivery network (CDN), a server, or any other desired equipment. Software executed by control circuitry 48 on external display 10B may include, for example, software used to control how external display 10B displays images, software used to control how external display 10B produces sound, software used to control wireless communications performed by external display 10B, operating system functions, interface functions, etc.

To support wireless communications with external equipment, control circuitry 14 and control circuitry 48 may be used in implementing communications protocols. Communications protocols that may be implemented using control circuitry 14 and control circuitry 48 include internet protocols, WLAN protocols (e.g., IEEE 802.11 protocols – sometimes referred to as Wi-Fi®), protocols for other wireless communications links such as the Bluetooth® protocol or other WPAN protocols, IEEE 802.11ad protocols, cellular telephone protocols (e.g., 3GPP 3G, 4G, 5G, or 6G protocols), MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), wireless charging (power transfer) protocols, short range communications link protocols (e.g., wireless data transfer protocols that support in-band full duplex communications), etc. Each communication protocol may be associated with a corresponding radio access technology (RAT) that specifies the physical connection methodology used in implementing the protocol.

Host device 10A may include input-output (I/O) devices 20. If desired, input-output devices 20 may include one or more displays 22. Display(s) 22 may display, produce, emit, generate, and/or output images 56 (e.g., visible light that has been modulated to contain a stream of image frames over time for viewing by a user). If desired, input-output devices 10 may include one or more sensors 31. Sensor(s) 31 may include a lid position sensor (e.g., in implementations where host device 10A is a laptop computer), light sensors, image sensors (e.g., one or more cameras), infrared sensors, light detection and ranging (lidar) sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and/or other sensors. Input-output devices 20 may also include user interface devices, data port devices, buttons, joysticks, scrolling wheels, touch pads, keypads, keyboards, microphones, cameras, speakers, status indicators, light sources, audio jacks and other audio port components, digital data port devices, and/or other input-output components.

External display 10B may include input-output devices 44. Input-output devices 44 may include one or more displays 46. Display(s) 46 may display, produce, emit, generate, and/or output images 58. In some implementations, a display 46 on external display 10B may be larger and/or may have higher resolution than a display 22 on host device 10A (e.g., images 58 may be larger and/or higher resolution than images 56). If desired, external display 10B may include fewer input-output devices than host device 10A. If desired, the input-output devices 44 on external display 10B may include one or more data ports (e.g., universal serial bus (USB) ports), one or more speakers (e.g., for outputting sound), and/or other devices. In general, input-output devices 44 may include any of the input-output devices of host device 10A and/or other input-output devices.

Host device 10A may include communications circuitry 23. Communications circuitry 23 may include one or more wired data ports 28. Communications circuitry 23 may include one or more wired data interfaces and/or port controllers operably coupled to wired data port(s) 28 (e.g., for controlling or coordinating the transfer of data via wired data port(s) 28). Wired data port(s) 28 may include, for example, USB ports (e.g., USB 1.0 ports, USB 2.0 ports, USB 3.0 ports, USB-C ports, micro USB ports, mini USB ports, etc.), DisplayPort ports, Ethernet ports, PCI ports, PCI Express (PCIe) ports, and/or any other desired types of ports containing one or more data pins for conveying data between host device 10A and another device over a wired communications path.

External display 10B may include communications circuitry 34. Communications circuitry 34 may include one or more wired data ports 38. Communications circuitry 34 may include one or more wired data interfaces and/or port controllers operably coupled to wired data port(s) 38 (e.g., for controlling or coordinating the transfer of data via wired data port(s) 38). Wired data port(s) 38 may include, for example, USB ports (e.g., USB 1.0 ports, USB 2.0 ports, USB 3.0 ports, USB-C ports, micro USB ports, mini USB ports, etc.), DisplayPort ports, Ethernet ports, Peripheral Component Interconnect (PCI) ports, PCIe ports, and/or any other desired types of ports containing one or more data pins for conveying data between host device 10A and another device over a wired communications path.

Wired data port(s) 28 and wired data port(s) 38 may each receive a wired communications path such as wired communications path 60. If desired, wired communications path 60 may include connectors that are coupled to (e.g., inserted in, mated with, etc.) wired data port(s) 28 and wired data port(s) 38. Wired communications path 60 may include one or more wires, cables, and/or pins that convey data, control signals, and/or power between two or more devices. Wired communications path 60 is sometimes also referred to herein as wired data path 60, data path 60, or wired path 60.

Wired data port(s) 28, wired communications path 60, and wired data port(s) 38 may each support and/or implement one or more wired/electrical data transfer interfaces or protocols (e.g., USB protocols, Thunderbolt protocols, HDMI protocols, serial protocols, PCI protocols, PCIe protocols, etc.). The wired data transfer interfaces/protocols supported by host device 10A may be the same as the wired data transfer interfaces/protocols supported by external display 10B or, in some cases, host device 10A may support one or more wired data transfer interfaces/protocols that are not supported by external display 10B or vice versa.

Communications circuitry 23 on device 10 may also include wireless communications circuitry. The wireless communications circuitry may include one or more antennas 30, one or more radios 26, and one or more radio-frequency transmission line paths 32 that couple radio(s) 26 to antenna(s) 30. A radio 26 may include circuitry that operates on signals at baseband frequencies (e.g., baseband circuitry) and radio-frequency transceiver circuitry. The radio-frequency transceiver circuitry may include one or more transmitters and/or one or more receivers. A transmitter in radio 26 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 30. A receiver in radio 26 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 30. The components of a radio 26 may be mounted onto a single substrate or integrated into a single integrated circuit, chip, package, or system-on-chip (SOC) or may be distributed between multiple substrates, integrated circuits, chips, packages, or SOCs.

Because external display 10B is a wireless-enabled device, the communications circuitry 34 on external display 10B also includes wireless communications circuitry. The wireless communications circuitry may include one or more antennas 40, one or more radios 36, and one or more radio-frequency transmission line paths 42 that couple radio(s) 36 to antenna(s) 40. A radio 36 may include circuitry that operates on signals at baseband frequencies (e.g., baseband circuitry) and radio-frequency transceiver circuitry. The radio-frequency transceiver circuitry may include one or more transmitters and/or one or more receivers. A transmitter in radio 36 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 40. A receiver in radio 36 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 40. The components of a radio 36 may be mounted onto a single substrate or integrated into a single integrated circuit, chip, package, or system-on-chip (SOC) or may be distributed between multiple substrates, integrated circuits, chips, packages, or SOCs.

The antenna(s) 30 on host device 10A and the antenna(s) 40 on external display 10B may be formed using any desired antenna structures for conveying radio-frequency signals. For example, antenna(s) 40 and/or 30 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of the antennas over time. If desired, two or more of antennas 30 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction. If desired, two or more of antennas 40 may be integrated into a phased antenna array.

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 40 and antenna(s) 30 may transmit the radio-frequency signals by radiating the radio-frequency signals into free space (or to free space through intervening device structures such as a dielectric cover layer). Antenna(s) 40 and antenna(s) 30 may additionally or alternatively receive the radio-frequency signals from free space (e.g., through intervening devices structures such as a dielectric cover layer). The transmission and reception of radio-frequency signals by an antenna each involves the excitation or resonance of antenna currents on an antenna resonating element in the antenna by the radio-frequency signals within the frequency band(s) of operation of the antenna.

Radio-frequency transmission line paths 32 and 42 may each include one or more radio-frequency transmission lines such as coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more radio-frequency line paths 32 may be shared between multiple radios 26 if desired. One or more radio-frequency line paths 42 may be shared between multiple radios 36 if desired. If desired, one or more radio-frequency front end (RFFE) modules may be interposed on one or more radio-frequency transmission line paths 32 and/or on one or more radio-frequency transmission line paths 42. The radio-frequency front end modules may include substrates, integrated circuits, chips, or packages that are separate from the radios and may include filter circuitry, switching circuitry, amplifier circuitry, impedance matching circuitry, radio-frequency coupler circuitry, and/or any other desired radio-frequency circuitry for operating on the radio-frequency signals conveyed over the corresponding radio-frequency transmission line path(s).

Radios 26 and 36 may each transmit and/or receive radio-frequency signals within corresponding frequency bands at radio frequencies (sometimes referred to herein as communications bands or simply as “bands”). The frequency bands handled by radios 26 and 36 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, cellular sidebands, 6G bands between 100-1000 GHz (e.g., sub-THz, THz, or THF bands), etc.), other centimeter or millimeter wave frequency bands between 10-300 GHz (e.g., a short range wireless data transfer band that supports in-band full duplex communications such as a band between around 57 GHz and 64 GHz), near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, industrial, scientific, and medical (ISM) bands such as an ISM band between around 900 MHz and 950 MHz or other ISM bands below or above 1 GHz, D2D bands, P2P bands, satellite communications (satcom) bands, one or more unlicensed bands, one or more bands reserved for emergency and/or public services, and/or any other desired frequency bands of interest. One or more of the radios may also be used to perform spatial ranging operations if desired.

The example of FIG. 1 is illustrative and non-limiting. Although control circuitry 14 is shown separately from communications circuitry 23 and control circuitry 48 is shown separately from communications circuitry 34 in the example of FIG. 1 for the sake of clarity, communications circuitry 23 may include processing circuitry (e.g., one or more processors) that forms a part of processing circuitry 18 of control circuitry 14 (e.g., portions of control circuitry 14 may be implemented on communications circuitry 23), communications circuitry 23 may include storage circuitry that forms a part of storage circuitry 16 of control circuitry 14, communications circuitry 34 may include storage circuitry that forms a part of storage circuitry 50 of control circuitry 48, and/or communications circuitry 34 may include processing circuitry that forms a part of processing circuitry 52 of control circuitry 48. As an example, control circuitry 14 may include baseband circuitry (e.g., one or more baseband processors), digital control circuitry, analog control circuitry, and/or other control circuitry that forms part of one or more radios 26. The baseband circuitry may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer.

Host device 10A may transmit control signals, power, and/or data to external display 10B via wired data port(s) 28, wired communications path 60, and wired data port(s) 38. Additionally, or alternatively, external display 10B may transmit control signals, power, and/or data to host device 10A via wired data port(s) 38, wired communications path 60, and wired data port(s) 28. For example, when wired communications path 60 is coupled to wired data port(s) 28 and wired data port(s) 38, control circuitry 14 on host device 10A may transmit display data DDAT to external display 10B via wired data port(s) 28, wired communications path 60, and wired data port(s) 38 (as shown by arrow 66). Control circuitry 48 on external display 10B (e.g., one or more display drivers) may drive display(s) 46 to display the display data DDAT received from host device 10A. The images 58 displayed by display(s) 46 may, for example, contain the stream of image frames in display data DDAT.

If desired, display(s) 22 on host device 10A may concurrently display the display data DDAT transmitted to host device 10B (e.g., in a mirrored display or mirrored desktop configuration). Alternatively, display(s) 22 on host device 10A may display a first portion of a stream of images while display(s) 46 on external display 10B concurrently display a second portion of the stream of images (e.g., where display data DDAT includes the second portion of the stream of images). In this configuration, sometimes also referred to as an extended display or extended desktop configuration, the first and second portions of the stream of images may collectively form an extended display or extended desktop for host device 10A (e.g., having a higher resolution than a single display 22 on its own). If desired, host device 10A may switch between a mirrored display configuration and an extended display configuration (e.g., responsive to an instruction issued by a software application running on host device 10A, responsive to a user input instructing host device 10A to switch between mirrored and extended display configurations, etc.). If desired, host device 10A may forego displaying images 56 using display(s) 22 while driving external monitor 10B to display the display data DDAT transmitted over wired data port(s) 28 and wired communications path 60 (e.g., external display 10B may form an external display or monitor for host device 10A).

Host device 10A may convey wireless data WDAT with an external device such as a node or end host of network 6. Wireless data WDAT may include a stream or series of data symbols, packets, frames, datagrams, and/or other structures. Wireless data WDAT may include message data, web browsing data, voice data, video data, gaming data, cloud data, navigation data, map data, document data, one or more data files, image data, text data, email data, and/or any other desired application data. One or more software applications running on host device 10A may transmit the wireless data for receipt by the external device and/or may receive the wireless data from the external device.

Radio(s) 26 may use antenna(s) 30 to convey radio-frequency signals 70 with AP 2 of wireless network 4. Radio-frequency signals 70 may form, support, and/or maintain a corresponding wireless link or connection between host device 10A and wireless network 4. Radio-frequency signals 70 may carry wireless data WDAT. Radio-frequency signals 70 may convey wireless data WDAT in an uplink (UL) direction from host device 10A to AP 2 and/or in a downlink (DL) direction from AP 2 to host device 10A. AP 2 may route or forward wireless data WDAT between host device 10A and the external device in network 6.

Radio(s) 36 on external display 10B may use antenna(s) 40 to convey radio-frequency signals 72 with AP 2 of wireless network 4. Radio-frequency signals 72 may form, support, and/or maintain a corresponding wireless link or connection between external display 10B and wireless network 4. If desired, radio(s) 36 may convey its own wireless data with an external device using radio-frequency signals 72. For example, radio(s) 36 may generate and transmit additional wireless data (different than wireless data WDAT) to the external device using radio-frequency signals 72 and/or may receive additional wireless data (different than wireless data WDAT) addressed to external display 10B using radio-frequency signals 72.

If desired, host device 10A may wirelessly communicate with external display 10B using radio-frequency signals 68. Radio-frequency signals 68 may form, support, and/or maintain a corresponding wireless link or connection between external display 10B and wireless network 4 (e.g., a WPAN link, a P2P link, a D2D link, a WLAN link, etc.). If desired, radio-frequency signals 68 may carry wireless data (e.g., wireless data WDAT, display data DDAT, control signals, and/or additional wireless data). If desired, one or more of the operations of wired communications path 60 as described herein can additionally, or alternatively, be performed using the wireless link formed by radio-frequency signals 68.

In practice, host device 10A and external display 10B may exhibit different levels of wireless performance in wirelessly communicating with AP 2. The different levels of wireless performance may be caused by differences between the hardware and/or software implemented on host device 10A and the hardware and/or software implemented on external display 10B, differences in the power or battery level of host device 10A relative to external display 10B, and/or the radio-frequency propagation characteristics (e.g., channel conditions) between host device 10A and AP 2 being different than the radio-frequency propagation characteristics (e.g., channel conditions) between external display 10B and AP 2. For example, an external object may be covering antenna(s) 30 and/or may be blocking one or more radio-frequency propagation paths between antenna(s) 30 and AP 2, an external object may be covering antenna(s) 40 and/or may be blocking one or more radio-frequency propagation paths between antenna(s) 40 and AP 2, antenna(s) 30 may be loaded or detuned by an external object, antenna(s) 40 may be loaded or detuned by an external object, host device 10A may exhibit a low battery level and/or may be operated in a low power mode having reduced functionality, radio(s) 26 and/or antenna(s) 30 may exhibit hardware non-idealities not present in radio(s) 36 and/or antenna(s) 40, etc.

The wireless performance of host device 10A in communicating with AP 2 and the wireless performance of external display 10B in communicating with AP 2 may be characterized by one or more wireless performance metrics (sometimes also referred to herein as key performance indicators (KPIs)). Host device 10A and/or external display 10B may generate wireless performance metric data associated with the wireless performance metric(s). The wireless performance metric data may include transmit power levels, received power levels, received signal strength indicator (RSSI) values, noise floor levels, noise levels, signal-to-noise ratio values, error rate values, adjacent channel leakage ratio values, distortion levels, signal quality levels, quality factor values, signal-to-interference-plus-noise ratio values, failure rate values, antenna impedance values, voltage standing wave ratio (VSWR) values, link closure rate values, data rate values, bandwidth values, etc.

In situations where host device 10A exhibits a higher level of wireless performance than external display 10B (or a level of wireless performance greater than a threshold), host device 10A may use radio-frequency signals 70 to convey wireless data WDAT directly between host device 10A and AP 2 (e.g., over-the-air (OTA) between host device 10A and AP 2 without routing the wireless data through external display 10B). For example, during data transmission, radio(s) 26 may modulate wireless data WDAT onto radio-frequency signals 70. Radio(s) 26 may use antenna(s) 30 to transmit radio-frequency signals 70 (carrying wireless data WDAT) to AP 2. AP 2 may forward wireless data WDAT to its corresponding destination device (e.g., an end host of network 6).

On the other hand, in situations where host device 10A exhibits a lower level of wireless performance than external display 10B (or a level of wireless performance less than a threshold level of wireless performance), host device 10A may bypass its own radio(s) 26 and antenna(s) 30 and may instead use external display 10B to convey wireless data WDAT between host device 10A and AP 2. This may help to minimize errors, disruption, and/or data loss between host device 10A and AP 2 (e.g., helping to maintain a satisfactory user experience in interacting with host device 10A).

When host device 10A is plugged into external display 10B by wired communications path 60, host device 10A may use wired data port(s) 28, wired communications path 60, and wired data port(s) 38 to convey wireless data WDAT between host device 10A and external display 10B (as shown by arrow 62). For example, during data transmission, radio(s) 26 (e.g., baseband circuitry in radio(s) 26) may transmit wireless data WDAT (e.g., baseband data) to wired data port(s) 28. Wired data port(s) 28 may transmit wireless data WDAT to wired data port(s) 38 on external display 10B over wired communications path 60 (e.g., using the strongest wired communications protocol supported by both host device 10A and external display 10B). External display 10B may receive wireless data WDAT via wired communications path 60 and wired data port(s) 38. Wired data port(s) 38 may transmit wireless data WDAT to radio(s) 36. Radio(s) 36 may modulate wireless data WDAT onto radio-frequency signals 72. Radio(s) 36 may use antenna(s) 34 to transmit radio-frequency signals 72 (carrying wireless data WDAT) to AP 2. AP 2 may forward wireless data WDAT to its corresponding destination device (e.g., an end host of network 6).

Conversely, during data reception, antenna(s) 40 on external display 10B may receive radio-frequency signals 72 (carrying wireless data WDAT transmitted by a source device) from AP 2. Antenna(s) 40 may pass the received radio-frequency signals 72 to radio(s) 36. Radio(s) 36 may downconvert, recover, extract, and/or otherwise identify the wireless data WDAT carried by the received radio-frequency signals 72. Radio(s) 36 (e.g., baseband circuitry in radio(s) 36) may pass wireless data WDAT (e.g., baseband data) to wired data port(s) 38. Wired data port(s) 38 may transmit wireless data WDAT to wired data port(s) 28 on host device 10A over wired communications path 60 (e.g., using the strongest wired communications protocol supported by both host device 10A and external display 10B). Host device 10A may receive wireless data WDAT via wired communications path 60 and wired data port(s) 28. Wired data port(s) 28 may pass wireless data WDAT to radio(s) 26 (e.g., to baseband circuitry on radio(s) 26). Radio(s) 26 may decode and/or demodulate wireless data WDAT and may pass the decoded data up the protocol stack for further processing.

While referred to as a single wired communications path 60 for the sake of simplicity, wired communications path 60 may include multiple wired communications paths or cables coupled in parallel between multiple wired data ports 28 and multiple wired data ports 38 if desired (e.g., the operations of wired communications path 60 as described herein may be performed by any desired number of one or more wired communications paths or cables). If desired, wired data port(s) 28 may convey both wireless data WDAT and display data DDAT over the same set of one or more pins of wired data port(s) 28 or may convey wireless data WDAT over a first set of one or more pins of wired data port(s) 28 while conveying display data DDAT over a second set of one or more pins of wired data port(s) 28. Similarly, wired data port(s) 38 may convey both wireless data WDAT and display data DDAT over the same set of one or more pins of wired data port(s) 38 or may convey wireless data WDAT over a first set of one or more pins of wired data port(s) 38 while conveying display data DDAT over a second set of one or more pins of wired data port(s) 38. Wired communications path 60 may convey both wireless data WDAT and display data DDAT over the same conductive line(s), cable(s), wire(s), and/or pin(s) or may carry wireless data WDAT and display data DDAT over different conductive lines, cables, wires, and/or pins.

In some implementations, if desired, host device 10A and external display 10B may wirelessly exchange wireless data WDAT using radio-frequency signals 68 instead of conveying the wireless data over wired communications path 60. However, wired communications path 60 may convey wireless data WDAT at higher data rates and/or with fewer errors than when radio-frequency signals 68 are used, particularly when the antenna(s) 30 on host device 10A exhibit poor channel conditions.

In this way, host device 10A may bypass its own radio(s) and antenna(s) and may instead use a wireless-enabled external device such as external display 10B to convey wireless data with AP 2 when external display 10B exhibits stronger wireless performance and/or propagation conditions with AP 2 than host device 10A. If desired, host device 10A may process wireless performance metric data generated by host device 10A and external display 10B to select and/or switch which of the devices is used to convey wireless data WDAT with AP 2 over time.

For example, radio(s) 26 may generate first wireless performance metric data associated with the performance of radio(s) 26 and antenna(s) 30 in conveying radio-frequency signals 70 with AP 2. At the same time, radio(s) 36 may generate second wireless performance metric data (RFM) associated with the performance of radio(s) 26 and antenna(s) 40 in conveying radio-frequency signals 72 with AP 2. Radio(s) 36 on external display 10B may transmit second wireless performance metric data RFM to radio(s) 26 on host device 10A via wired data port(s) 38, wired communications path 60, and wired data port(s) 28 (as shown by arrow 64), and/or using radio-frequency signals 68. Radio(s) 26 and/or processing circuitry 18 may compare the first wireless performance metric data to the second wireless performance metric data RFM received from external display 10B to identify whether host device 10A or external display 10B exhibits superior wireless performance for conveying wireless data WDAT between host device 10A and AP 2.

If/when the wireless performance of host device 10A (e.g., as characterized by the first wireless performance metric data) exceeds the wireless performance of exterior display 10B (e.g., as characterized by second wireless performance metric data RFM) or exceeds the wireless performance of exterior display 10B by more than a threshold amount, radio(s) 26 may use radio-frequency signals 70 to convey wireless data WDAT with AP 2 directly over the air. On the other hand, if/when the wireless performance of external display 10B (e.g., as characterized by first wireless performance metric data RFM) exceeds the wireless performance of host device 10A (e.g., as characterized by the first wireless performance metric data) or exceeds the wireless performance of host device 10A by more than a threshold amount, radio(s) 26 may convey wireless data WDAT with AP 2 via (through) external display 10B. If desired, host device 10A may implement a hysteresis algorithm to prevent switching between wireless communications using host 10A or external display 10B too quickly (e.g., so rapidly that overall wireless performance is deteriorated, so rapidly that the operation of other device systems are deteriorated, etc.).

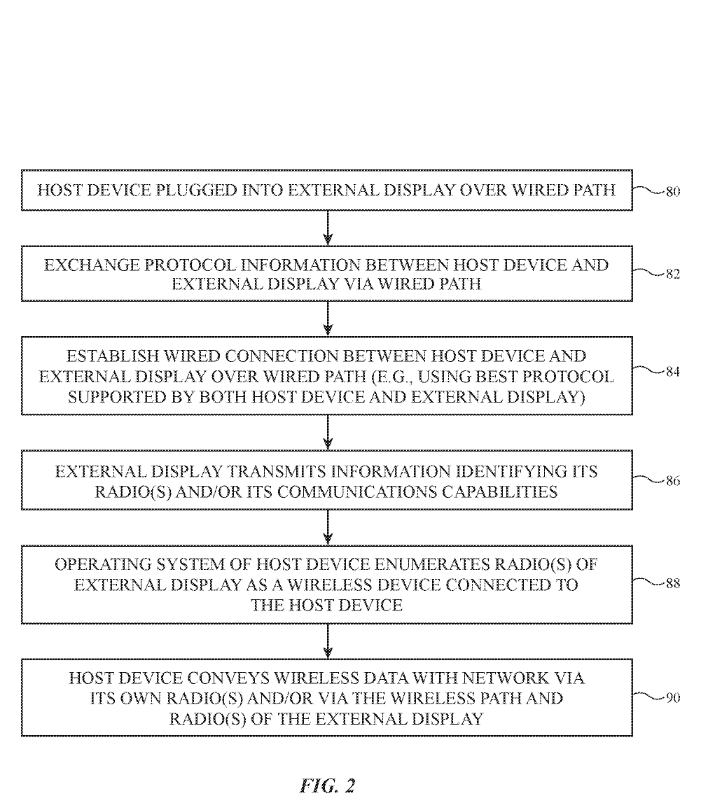

FIG. 2 is a flow chart of illustrative operations involved in using host device 10A and external display 10B to convey wireless data for the radio(s) 26 on host device 10A. At operation 80, host device 10A may be plugged into external display 10B over wired communications path 60 (e.g., a first end or connector of wired communications path 60 may be plugged into wired data port(s) 28 on host device 10A and a second end or connector of wired communications path 60 may be plugged into wired data port(s) 38 on external display 10B).

At operation 82, host device 10A and external display 10B may exchange protocol information over wired communications path 60. The protocol information may include information transmitted from host device 10A to external display 10B that identifies the wired communications protocols/interfaces supported by host device 10A and wired data port(s) 28. The protocol information may also include information transmitted from external display 10B to host device 10A that identifies the wired communications protocols/interfaces supported by external display 10B and wired data port(s) 38.

At operation 84, host device 10A and external display 10B may establish a wired connection or link between wired data port(s) 28 and wired data port(s) 38 through wired communications path 60. The wired connection may, for example, be a connection under or implementing the strongest wired communications protocol supported by both host device 10A and external display 10B (e.g., as identified from the information exchanged at operation 82). The strongest wired communications protocol may, for example, be the fastest (e.g., highest data rate), latest (e.g., newest or most recent), most robust, and/or least error prone wired communications protocol supported by both host device 10A and external display 10B.

At operation 86, external display 10B may transmit information identifying its radio(s) 36 and/or one or more communications capabilities of radio(s) 36 and antenna(s) 40 to host device 10A (e.g., over wired communications path 60 and/or using radio-frequency signals 68). Host device 10A may receive this information from external display 10B over wired communications path 60 and/or using radio-frequency signals 68. The one or more communications capabilities may include, for example, the frequency bands, RATs, modulation coding schemes, and/or communications protocols supported by the radio(s) 36 and antenna(s) 40 on external display 10B. External display 10B may proactively transmit this information to host device 10A or may transmit this information in response to a query received from host device 10A (e.g., host device 10A may wait to receive the information or may fetch the information from external display 10B).

At operation 88, the operating system of host device 10A may enumerate the radio(s) 36 of external display 10B as wireless device(s) that are connected to host device 10A. The operating system may, for example, list radio(s) 36 as being radios or wireless devices within, of, or coupled to host device 10A (e.g., as radio(s) accessible to host device 10A via a USB port of host device 10A). If desired, the operating system may display a graphical user interface (GUI) on display(s) 22 that displays the list of radios, wireless devices, or wireless chips available to host device 10A for communicating with wireless network 4. If desired, the host device may receive a user input selecting which of the radios, wireless devices, or wireless chips to use to wirelessly communicate with wireless network 4. However, one or more of the remaining operations of FIG. 2 may, if desired, be performed autonomously by host device 10A without a user input (e.g., without requiring the user to select which radio, wireless device, or wireless chip to use to wireless communicate with wireless network 4).

At operation 90, host device 10A may convey wireless data WDAT with AP 2 in wireless network 4 directly over the air (e.g., using radio-frequency signals 70) and/or via wired communications path 60 and external display 10B (e.g., using radio-frequency signals 72). If desired, host device 10A may switch, cycle, or toggle between conveying wireless data WDAT directly and conveying wireless data WDAT via external display 10B over time (e.g., as the wireless performance and/or channel conditions of host device 10A changes over time).

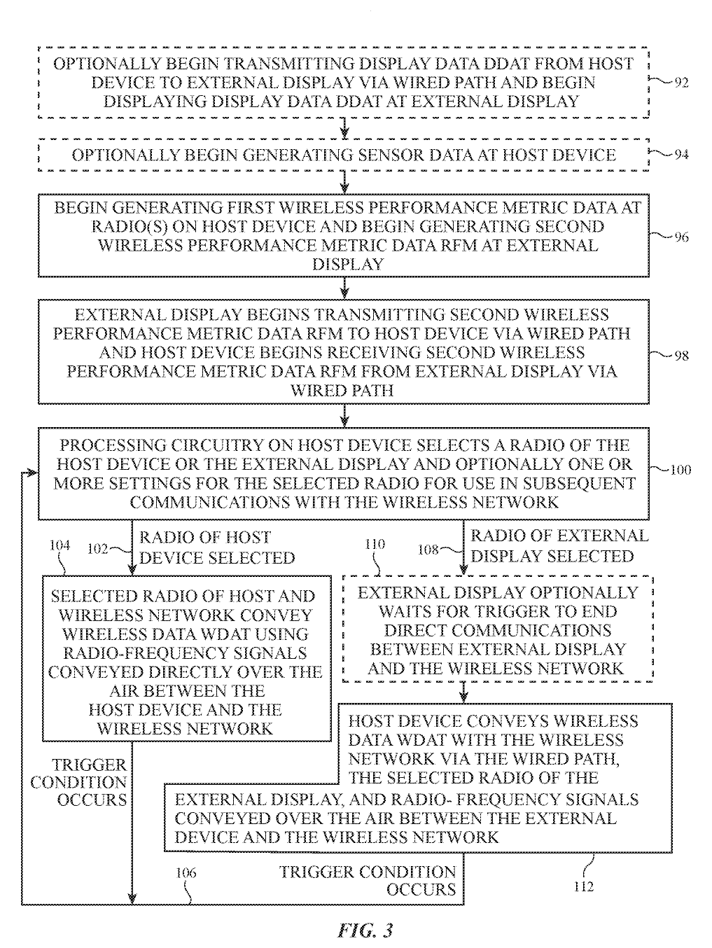

FIG. 3 is a flow chart of illustrative operations involved in conveying wireless data WDAT between host device 10A and AP 2 of wireless network 4. The operations of FIG. 3 may, for example, be performed while processing operation 90 of FIG. 2.

At optional operation 92, control circuitry 14 on host device 10A may begin transmitting display data DDAT to external display 10B for display by display(s) 46. External display 10B may receive display data DDAT and may pass display data DDAT to display(s) 46. Host device 10A may transmit display data DDAT to external display 10B via wired data port(s) 28, wired communications path 60, and wired data port(s) 38. Alternatively, host device 10A may transmit display data DDAT to external display 10B in radio-frequency signals 68.

Display(s) 46 on external display 10B may begin displaying the display data DDAT received from host device 10A (e.g., in images 58). If desired, host device 10A may continue to transmit display data DDAT to external display 10B and external display 10B may continue to display the display data DDAT received from host device 10A concurrent with one or more of the remaining operations of FIG. 3. Operation 92 may be omitted if desired (e.g., external display 10B need not display any display data for host device 10A).

At optional operation 94, sensor(s) 31 on host device 10A may begin generating sensor data. Operation 94 may be omitted if desired.

At operation 96, radio(s) 26 on host device 10A may begin generating first wireless performance metric data associated with the transmission and/or reception of radio-frequency signals 70 by antenna(s) 30 and radio(s) 26. If desired, host device 10A may generate the first wireless performance metric data in a first set of frequency bands supported by radio(s) 26. For example, radio(s) 26 may perform a frequency scan or sweep over the first set of frequency bands while generating the first wireless performance metric data (e.g., while measuring one or more characteristics of transmitted and/or received radio-frequency signals 70).

Radio(s) 36 on external display 10B may also begin generating second wireless performance metric data RFM associated with the transmission and/or reception of radio-frequency signals 72 by antenna(s) 40 and radio(s) 36. If desired, external display 10B may generate second wireless performance metric data RFM in a second set of frequency bands supported by radio(s) 36. For example, radio(s) 36 may perform a frequency scan or sweep over the second set of frequency bands while generating second wireless performance metric data RFM (e.g., while measuring one or more characteristics of transmitted and/or received radio-frequency signals 72). The second set of frequency bands may be the same as the first set of frequency bands. Alternatively, the second set of frequency bands may include one or more frequency bands not included in the first set of frequency bands or vice versa.

Host device 10A and external display 10B may generate the first and second wireless performance metric data concurrently or during different respective time periods. External display 10B may generate second wireless performance metric data RFM proactively (e.g., without being triggered or instructed to do so by host device 10A) or host device 10A may control, trigger, command, and/or instruct external display 10B to begin generating second wireless performance metric data RFM (e.g., using control signals conveyed over wired communications path 60). Radio(s) 26 may continue to generate and/or update the first wireless performance metric data and/or radio(s) 37 may continue to generate and/or update second wireless performance metric data RFM concurrent with one or more of the remaining operations of FIG. 3.

At operation 98, external display 10B may begin transmitting second wireless performance metric data RFM to host device 10A. Host device 10A may receive second wireless performance metric data RFM and may pass second wireless performance metric data RFM to radio(s) 26 and/or control circuitry 14. External display 10B may transmit second wireless performance metric data RFM to host device 10A via wired data port(s) 38, wired communications path 60, and wired data port(s) 28. Alternatively, external display 10B may transmit second wireless performance metric data RFM to host device 10A in radio-frequency signals 68. External display 10B may continue to transmit wireless performance metric data RFM to host device 10A concurrent with one or more of the remaining operations of FIG. 3.

At operation 100, processing circuitry 18 on host device 10A may select either a radio 26 on host device 10A or a radio 36 on external display 10B for conveying wireless data WDAT. Processing circuitry 18 may perform this selection based on the first wireless performance metric data generated at host device 10A, the second wireless performance metric data RFM generated at external display 10B, and/or the sensor data generated at host device 10A. If desired, processing circuitry 18 may also select one or more settings for the selected radio based on the first wireless performance metric data generated at host device 10A, the second wireless performance metric data RFM generated at external display 10B, and/or the sensor data generated at host device 10A. The settings may include frequency settings, modulation coding scheme settings, antenna settings, phase and magnitude settings (e.g., for performing beamforming using a phased antenna array), power level settings, etc.

For example, processing circuitry 18 may select a radio 26 on host device 10A if/when the selected radio 26 exhibits stronger wireless performance than any of the radios 36 on external display 10B (e.g., across the first set of frequency bands supported by host device 10A), if/when the first wireless performance metric data is stronger than second wireless performance metric data RFM, if/when the first wireless performance metric data exceeds a lower threshold, if/when the first wireless performance metric data is less than an upper threshold, and/or if/when the first wireless performance metric data is superior to second wireless performance metric data RFM by at least a predetermined margin or amount.

On the other hand, processing circuitry 18 may select a radio 36 on external display 10B if/when the selected radio 36 exhibits stronger wireless performance than any of the radios 26 on host device 10A (e.g., across the second set of frequency bands supported by external display 10B), if/when second wireless performance metric data RFM is stronger than the first wireless performance metric data, if/when second wireless performance metric data RFM exceeds a lower threshold, if/when second wireless performance metric data RFM is less than an upper threshold, and/or if/when second wireless performance metric data RFM is superior to the first wireless performance metric data RFM by at least a predetermined margin or amount.

If desired, processing circuitry 18 may account for situations where the first set of frequency bands supported by radio(s) 26 differs from the second set of frequency bands supported by radio(s) 36 in selecting whether to convey wireless data WDAT using host device 10A or external display 10B. Consider one example in which the first set of frequency bands supported by radio(s) 26 includes a 2.4 GHz WLAN band and a 5.0 GHz WLAN band but the second set of frequency bands supported by radio(s) 36 includes only the 2.4 GHz WLAN band but not the 5.0 GHz WLAN band. In this example, processing circuitry 18 may select radio 26 for conveying wireless data WDAT if/when the wireless performance of radio 26 in the 5.0 GHz WLAN band exceeds the wireless performance of the radio(s) 36 on external display 10B in the 2.4 GHz band. On the other hand, processing circuitry 18 may select radio 36 for conveying wireless data WDAT if/when the wireless performance of radio 36 in the 2.4 GHz WLAN band exceeds the wireless performance of the radio(s) 26 on host 10A in both the 2.4 GHz WLAN band and the 5.0 GHz WLAN band (e.g., when the data rate or RSSI of radio 36 in the 2.4 GHz WLAN band exceeds the data rate or RSSI of radio 26 in both the 2.4 GHz and 5.0 GHz WLAN bands). If desired, processing circuitry 18 may also account for different RATs supported by radio(s) 26 and radio(s) 36 in a similar manner to select a best-performing combination of radio, RAT, and/or frequency for use in conveying wireless data WDAT (e.g., radio-frequency signals 70 need not be conveyed using the same RAT as radio-frequency signals 72, such as in implementations where radio-frequency signals 70 are transmitted using a WLAN RAT whereas radio-frequency signals 72 are transmitted using a WPAN RAT or another RAT or vice versa).

If desired, processing circuitry 18 may also select a particular antenna 40 on external display 10B for use in conveying wireless data WDAT for a selected radio 36 and/or may select a particular antenna 30 on host device 10A for use in conveying wireless data WDAT for a selected radio 26 (e.g., by comparing the first wireless performance metric data as gathered for/using different antennas 30 to the second wireless performance metric data RFM as gathered for/using different antennas 40). This may help to account for situations where the wireless performance of one antenna 30 differs from the wireless performance of another antenna 30 (e.g., in situations where one antenna is covered by an external object but not the other) and for situations where the wireless performance of one antenna 40 differs from the wireless performance of another antenna 40.

As another example, processing circuitry 18 may select a radio 26 or a radio 36 based at least in part on sensor data produced by sensor(s) 31. For example, processing circuitry 18 may use the sensor data to help identify, estimate, and/or predict which radio would exhibit superior wireless performance under the current environmental and/or operating conditions of host device 10A (e.g., under a sensor fusion scheme in which sensor data is combined with the first and second wireless performance metric data to predict a best performing radio or in a standalone scheme in which the sensor data is used to proactively select radio 26 or radio 36 regardless of the first and second wireless performance metric data).

In implementations where host device 10A is a laptop computer, for example, the position of a lid of the laptop computer relative to a base of the laptop computer can substantially impact the wireless performance of antenna(s) 30. For example, antenna(s) 30 may exhibit superior wireless performance when the lid is in an open position or at a high angle with respect to the base than when the lid is in a closed position or at a low angle with respect to the base. If desired, sensor(s) 31 may include a lid position sensor that generates lid position sensor data indicative of a position, orientation, and/or angle of the lid relative to the base of the laptop computer.

If/when the lid position sensor data is indicative of the lid being in an open position or at greater than a threshold angle relative to the base, processing circuitry 18 may select a radio 26 on host device 10A for conveying wireless data WDAT in radio-frequency signals 70. On the other hand, if/when the lid position sensor data is indicative of the lid being in a closed position or at less than a threshold angle relative to the base, processing circuitry 18 may select a radio 36 on external display 10B for conveying wireless data WDAT in radio-frequency signals 72 (e.g., under the assumption that the wireless performance of host device 10A will be worse than the wireless performance of external display 10B when the lid is closed). In general, any desired logic may be used to select a radio 26 or a radio 36, an antenna 30 or an antenna 40, and settings for the selected radio and antenna based on the first and second wireless performance metric data and/or the sensor data.

If/when processing circuitry 18 selects a radio 26 of host device 10A, processing may proceed to operation 104 via path 102. At operation 104 (e.g., responsive to processing circuitry 18 selecting a radio 26 of host device 10A, responsive to the first wireless performance metric data being stronger than second wireless performance metric data RFM, etc.), the selected radio 26 of host device 10A may convey wireless data WDAT with AP 2 (e.g., using the selected settings and/or the selected antenna 30) directly over-the-air in radio-frequency signals 70 (e.g., without passing wireless data WDAT through external display 10B).

The selected radio 26 may continue to convey wireless data WDAT in radio-frequency signals 70 until a trigger condition occurs. The trigger condition be when host device 10A receives a predetermined user input, an application on host device 10A issues a trigger signal, after a predetermined time period, after a predetermined amount of wireless data WDAT has been conveyed, when host device 10A is unplugged from external display 10B, when the first wireless performance metric data deteriorates by a predetermined amount (e.g., to worse than second wireless performance metric data RFM), when second wireless performance metric data RFM improves by a predetermined amount (e.g., to better than the first wireless performance metric data), when another device is connected to external display 10B and/or host device 10A, when the wireless data requirements of host device 10A change, and/or any other desired trigger condition. In response to the trigger condition, processing may loop back to operation 100 via path 106 to update the device used to convey wireless data WDAT. If desired, the trigger condition may implement a hysteresis algorithm to prevent switching to conveying wireless data WDAT using external display 10B too frequently (e.g., only triggering a loop back to operation 100 after at least a predetermined time period has elapsed).

If/when processing circuitry 18 selects a radio 36 of external display 10B, processing may proceed from operation 100 to optional operation 110 via path 108. Optional operation 110 may be performed, for example, in situations where external display 10B is already conveying its own wireless data directly with wireless network 4 in radio-frequency signals 72. This wireless data may include data generated by external display 10B (rather than host device 10A) and/or may include data generated by an external device for receipt by external display 10B (e.g., the wireless data may have a destination address corresponding to external display 10B).

At optional operation 110 (e.g., responsive to processing circuitry 18 selecting a radio 36 of external display 10B, responsive to second wireless performance metric data RFM being stronger than the first wireless performance metric data, etc.), external display 10B may wait for a trigger signaling the end of direct communications between external display 10B and wireless network 4. The trigger may be, for example, receipt of a control signal from host device 10A instructing external display 10B to stop direct communications with wireless network 4 (e.g., as received via wired communications path 60 or radio-frequency signals 68), receipt of a user input provided to a user input device of external display 10B, the passage of a predetermined time period, etc. Processing may proceed to operation 112 once external display 10B has stopped direct communications with wireless network 4. Optional operation 110 may be omitted if desired.

At operation 112, the selected radio 36 of external display 10B may convey wireless data WDAT between host device 10A and AP 2 (e.g., using the selected settings and/or the selected antenna 40) directly over-the-air in radio-frequency signals 72. External display 10B may receive wireless data WDAT from host device 10A over wired communications path 60 and/or in radio-frequency signals 68. External display 10B may transmit wireless data WDAT to host device 10A over wired communications path 60 and/or in radio-frequency signals 68. In this way, external display 10B may forward or route wireless data WDAT between radio(s) 26 on host device 10A and AP 2 while bypassing non-ideal radio-frequency propagation paths between host device 10A and AP 2. This may allow host device 10A to continue to convey wireless data WDAT with AP 2 even when one or more propagation paths between host device 10A and AP 2 have been blocked by an external object and/or when host device 10A exhibits insufficient levels of wireless performance.

The selected radio 36 may continue to convey wireless data WDAT in radio-frequency signals 72 until a trigger condition occurs. The trigger condition be when host device 10A and/or external display 10B receives a predetermined user input, an application on host device 10A and/or external display 10B issues a trigger signal, after a predetermined time period, after a predetermined amount of wireless data WDAT has been conveyed, when host device 10A is unplugged from external display 10B, when second wireless performance metric data RFM deteriorates by a predetermined amount (e.g., to worse than the first wireless performance metric data), when the first wireless performance metric data improves by a predetermined amount (e.g., to better than second wireless performance metric data RFM), when another device is connected to external display 10B and/or host device 10A, when the wireless data requirements of host device 10A change, when external display 10B has its own wireless data to convey with AP 2, and/or any other desired trigger condition. In response to the trigger condition, processing may loop back to operation 100 via path 106 to update the device used to convey wireless data WDAT. If desired, the trigger condition may implement a hysteresis algorithm to prevent switching to conveying wireless data WDAT using host device 10A too frequently (e.g., only triggering a loop back to operation 100 after at least a predetermined time period has elapsed).

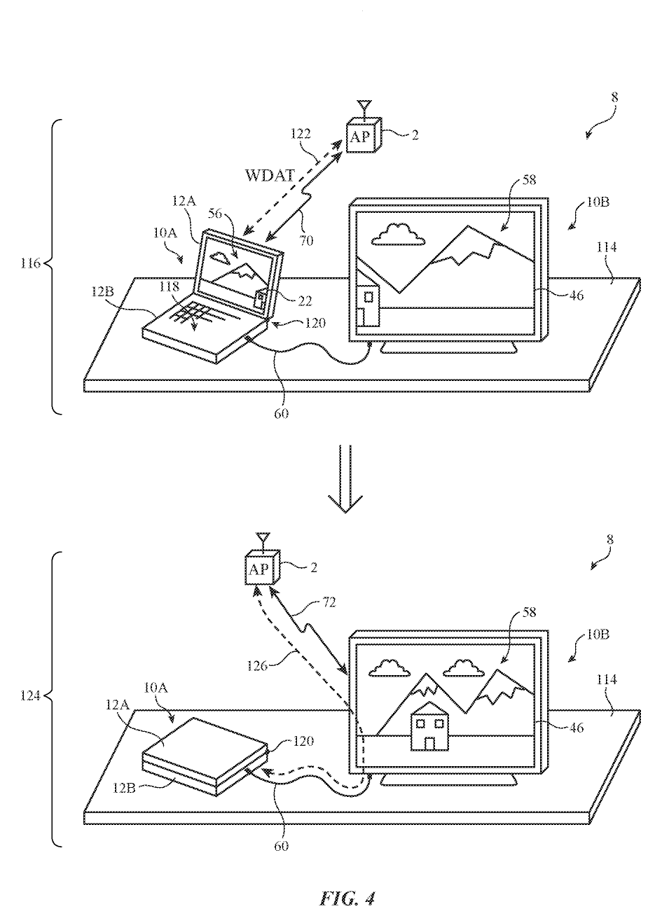

FIG. 4 is a perspective view illustrating one example in which host device 10A is a laptop computer. As shown in FIG. 4, host device 10A may be implemented as a laptop computer having an upper housing 12A coupled to a lower housing 12B by a hinge 120. Upper housing 12A is sometimes also referred to herein as lid 12A. Lower housing 12B is sometimes also referred to herein as base 12B. Base 12B may be placed on an underlying surface 114 (e.g., a desk or table). If desired, external display 10B may also be placed on surface 114.

Lid 12A may include a display 22 of host device 10A. Base 12B may include user input devices 118 such as a keyboard and/or trackpad. Lid 12A may rotate relative to base 12B about hinge 120 between a closed position and an open position. In portion 116 of FIG. 4, lid 12A is illustrated in an open position. The position/orientation of lid 12A relative to base 12B may be characterized by a corresponding lid angle. The lid angle may be zero degrees when the lid is in the closed position. The lid angle may be greater than or equal to 90 degrees when the lid is in the open position. Hinge 120 may hold lid 12A in place at any desired angles within the range of angles between the open and closed positions. If desired, a lid position sensor on host device 10A may generate lid position sensor data that identifies the position, orientation, and/or angle of lid 12A relative to base 12B.

Host 10A (e.g., base 12B) may include a wired data port 28 (FIG. 1) that is communicatively coupled to a wired data port 38 (FIG. 1) on external display 10B by wired communications path 60. Display 22 in lid 12A may display images 56. At the same time, wired communications path 60 may convey display data DDAT from host device 10A to external display 10B. Display data DDAT may cause a display 46 on external display 10B to display corresponding images 58. Host device 10A and external display 10B are operated in an extended display or extended desktop mode in the example of FIG. 4. In this configuration, the images 56 displayed on display 22 may include a first portion of a display, screen, or desktop whereas the images 58 displayed on display 46 include a second portion of the display, screen, or desktop.

Portion 124 of FIG. 4 illustrates host device 10A when lid 12A is in the closed position. If desired, host device 10A may continue to transmit display data DDAT to external display 10B over wired communications path 60 while the lid is in the closed position. When operating in the extended display mode, closing lid 12A may, for example, cause the display data DDAT transmitted to external display 10B to include both the first and second portions of the display, screen, or desktop that are otherwise split between displays 22 and 46 when lid 12A is in the open position.

As shown in portion 116 of FIG. 4, host device 10A may exhibit superior wireless performance in communicating with AP 2 than external display 10B while lid 12A is in the open position. As such, host device 10A may convey wireless data WDAT directly over-the-air with AP 2 in radio-frequency signals 70 (as shown by arrow 122) rather than conveying wireless data WDAT between external display 10B and host device 10A via wired communications path 60. In this example, host device 10A may select a radio 26 on host device 10A (e.g., while processing operation 100 of FIG. 3) based on the first wireless performance metric data generated by host device 10A, second wireless performance metric data RFM generated by external display 10B, and/or lid position sensor data generated on host device 10A.

As shown in portion 124 of FIG. 4, external display 10B may exhibit superior wireless performance in communicating with AP 2 than host device 10A while lid 12A is in the closed position. This may occur, for example, in implementations where the housing of lid 12A and the housing of base 12B are formed from metal and where the antennas 30 (FIG. 1) of host device 10A are mounted within base 12B (e.g., where a slot or aperture is formed in the housing of base 12B for passing radio-frequency signals to the antennas while lid 12A is in the closed position). Closure of lid 12A may, for example, cause conductive portions of the housing of lid 12A to block or reduce the slot or aperture in the housing of base 12B, partially blocking the radio-frequency signals 70 conveyed by the antennas.

As such, while lid 12A is in the closed position, host device 10A may convey wireless data WDAT with AP 2 via wired communications path 60, external display 10B, and radio-frequency signals 72 (as shown by arrow 126) rather than conveying wireless data WDAT between directly between host device 10A and AP 2. In this example, host device 10A may select a radio 36 on external display 10B (e.g., while processing operation 100 of FIG. 3) based on the first wireless performance metric data generated by host device 10A, second wireless performance metric data RFM generated by external display 10B, and/or lid position sensor data generated on host device 10A.

The example of FIG. 4 is illustrative and non-limiting. In general, host device 10A may be any desired type of device and external display 10B may be any desired type of device. External display 10B may be replaced with any desired type of device and need not have a display. The example of FIG. 1 in which radio(s) 36 and antenna(s) 40 are included within external display 10B is illustrative and non-limiting. If desired, radio(s) 36 and antenna(s) 40 may be included within a peripheral device that is coupled to a wired data port 38 of external display 10B.

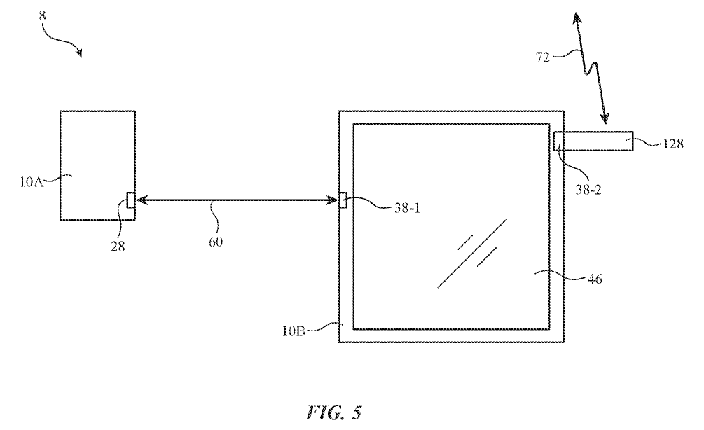

FIG. 5 is a diagram showing one example in which radio(s) 36 and antenna(s) 40 are included in a peripheral device 128 of external display 10B. Peripheral device 128 may be a wireless-enabled USB stick or dongle, as one example. External display 10B need not be a wireless-enabled device in these implementations.

As shown in FIG. 5, wired communications path 60 may be coupled to a first wired data port 38-1 of external display 10B. External display 10B may include another wired data port 38-2 that receives a peripheral device 128. Peripheral device 128 may contain radio(s) 36 and antenna(s) 40 (FIG. 1). In these implementations, host device 10A may enumerate the radio(s) in peripheral device 128 as a wireless device connected to host device 10A (e.g., while processing operation 88 of FIG. 2). When a radio 36 is selected to convey wireless data WDAT in the place of host device 10A, wireless data WDAT may be conveyed between host device 10A and peripheral device 128 via a wired data port 28 on host device 10A, wired communications path 60, wired data port 38-1 on external display 10B, a communications bus in external display 10B, and wired data port 38-2. Peripheral device 128 may convey wireless data WDAT in radio-frequency signals 72 instead of external display 10B.

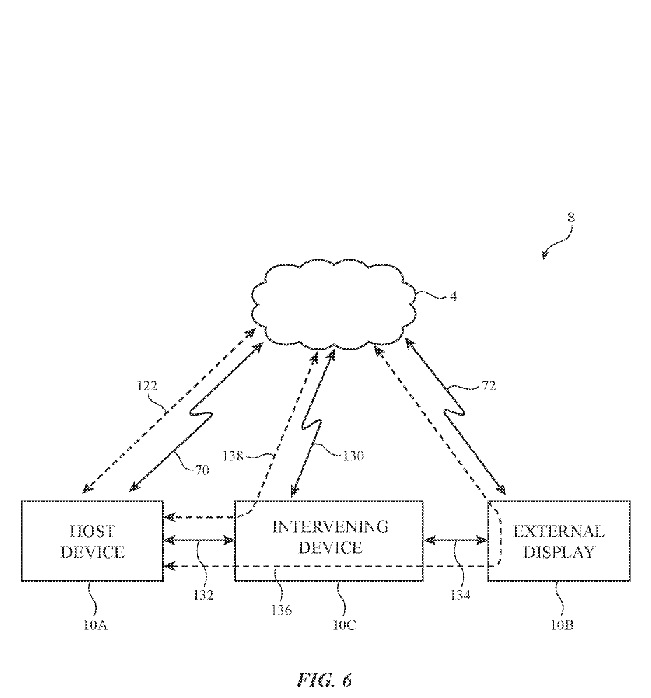

FIG. 6 illustrates another example in which host device 10A is communicatively coupled to external display 10B through an intervening device 10C. As shown in FIG. 6, host device 10A may be communicatively coupled to intervening device 10C over communications path 132. Intervening device 10C may be communicatively coupled to external display 10B over communications path 134.

Communications path 132 may include a wired communications path (e.g., wired communications path 60 of FIG. 1) coupled between wired data ports on host device 10A and intervening device 10C or may include a wireless communications path maintained by radio-frequency signals conveyed between antennas on host device 10A and intervening device 10C. Communications path 134 may include a wired communications path (e.g., wired communications path 60 of FIG. 1) coupled between wired data ports on intervening device 10C and external display 10B or may include a wireless communications path maintained by radio-frequency signals conveyed between antennas on external display 10B and intervening device 10C.

Intervening device 10C may be a wireless-enabled device or may be a device without wireless capabilities. External display 10B may be a wireless-enabled device or may be a device without wireless capabilities. In implementations where both intervening device 10C and external display 10B have wireless capabilities, host device 10A may receive wireless performance metric data from both intervening device 10C and external display 10B for selecting a best-performing radio of host device 10A, intervening device 10C, or external display 10B to use to convey wireless data WDAT with wireless network 4.

If/when a radio on host device 10A exhibits superior wireless performance to the radios on intervening device 10C and external display 10B, host device 10A may convey wireless data WDAT with wireless network 4 in radio-frequency signals 70, as shown by arrow 122. If/when a radio on intervening device 10C exhibits superior wireless performance to the radios on host device 10A and external display 10B, host device 10A may convey wireless data WDAT with wireless network 4 via communications path 132, intervening device 10C, and radio-frequency signals 130 conveyed between the radio on intervening device 10C and wireless network 4 (as shown by arrow 138). If/when a radio on external display 10B exhibits superior wireless performance to the radios on host device 10A and intervening device 10C, host device 10A may convey wireless data WDAT with wireless network 4 via communications path 132, intervening device 10C, communications path 134, external display 10B, and radio-frequency signals 72 (as shown by arrow 136).

In implementations where intervening device 10C is a wireless-enabled device and where external display 10B does not have wireless functionality, host device 10A may choose between a radio on host device 10A or a radio on intervening device 10C for use in conveying wireless data WDAT (e.g., where intervening device 10C replaces external display 10B while processing the operations of FIG. 3). In this example, intervening device 10C may be a portable media player device and external display 10B may be a television connected to the portable media player device, for example. Host device 10A may transmit display data DDAT to external display 10B via intervening device 10C and communications paths 132 and 134 for display at external display 10B. Alternatively, intervening device 10C may have no wireless functionality whereas external display 10B has wireless functionality. This may be generalized to any desired number of intervening devices.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An electronic device comprising:
a radio;
an antenna communicatively coupled to the radio;
a data port configured to receive a cable; and
processing circuitry configured to transmit display data to an external display device via the data port and the cable, wherein
the radio is configured to use the antenna to transmit, at a first time, first wireless data to a wireless network in a first radio-frequency signal, and
the radio is configured to transmit, at a second time, second wireless data to the wireless network via the data port, the cable, and a second radio-frequency signal conveyed between the external display device and the wireless network.

2. The electronic device of claim 1, wherein the radio is configured to generate first wireless performance metric data, the processing circuitry being further configured to receive, from the external display device via the cable and the data port, second wireless performance metric data associated with an additional radio on the external display device.

3. The electronic device of claim 2, the processing circuitry being configured to switch between communicating with the wireless network via the radio and communicating with the wireless network via the external display device based on the first wireless performance metric data and the second wireless performance metric data.

4. The electronic device of claim 3, wherein the first wireless performance metric data comprises a first received signal strength indicator (RSSI) value and the second wireless performance metric data comprises a second RSSI value.

5. The electronic device of claim 3, wherein the first wireless performance metric data comprises a first data rate value and the second wireless performance metric data comprises a second data rate value.

6. The electronic device of claim 1, wherein the radio is configured to transmit the first wireless data and the second wireless data concurrent with transmission of the display data to the external display.

7. The electronic device of claim 6, wherein the data port comprises a universal serial bus (USB) port or a DisplayPort port.

8. The electronic device of claim 6, further comprising:
a display, wherein the display is configured to display additional display data concurrent with transmission of the display data to the external display.

9. The electronic device of claim 1, wherein the first radio-frequency signal is in a first frequency band and the second radio-frequency signal is in a second frequency band different than the first frequency band.

10. The electronic device of claim 1, wherein the first radio-frequency signal is conveyed using a first radio access technology (RAT) and the second radio-frequency signal is conveyed using a second RAT different from the first RAT.

11. A method of operating a host device communicatively coupled to an external display over a wired path, the method comprising:
driving, using a data port on the host device and the wired path, the external display to display images;
generating, using a first radio on the host device, first wireless performance metric data associated with operation of the first radio;
receiving, using the data port, second wireless performance metric data from the external display via the wired path, the second wireless performance metric data being associated with operation of a second radio external to the host device; and
selecting, based on the first and second wireless performance metric data, either the first radio or the second radio for use in conveying wireless data between the host device and a wireless network.

12. The method of claim 11, further comprising:
conveying, using a first antenna on the host device, the wireless data between the first radio and the wireless network responsive to the first and second wireless performance metric data being indicative of the first radio exhibiting a higher level of wireless performance than the second radio; and
conveying, using the data port, the wired path, the second radio, and a second antenna communicatively coupled to the second radio, the wireless data between the host device and the wireless network responsive to the first and second wireless performance metric data being indicative of the second radio exhibiting a higher level of wireless performance than the first radio.

13. The method of claim 12, wherein the first and second wireless performance metric data comprise received signal strength indicator (RSSI) values or data rate values.

14. The method of claim 12, wherein the second antenna and the second radio are disposed in a peripheral device mounted to an additional data port of the external monitor.

15. The method of claim 11, further comprising:
transmitting, using the first radio and an antenna on the host device, the wireless data concurrent with driving the external display to display the images; and
switching from using the first radio to convey the wireless data to using the second radio to convey the wireless data responsive to a decrease in the first wireless performance metric data.

16. The method of claim 11, further comprising:
transmitting, to the second radio on the external display via the data port and the wired path, the wireless data concurrent with driving the external display to display the images; and
switching from using the second radio to convey the wireless data to using the first radio to convey the wireless data responsive to a decrease in the second wireless performance metric data.

17. The method of claim 11, wherein the host device comprises a laptop computer having a base and a lid, the method further comprising:
transmitting, using the first radio and an antenna on the host device, the wireless data concurrent with driving the external display to display the images; and
switching from using the first radio to convey the wireless data to using the second radio to convey the wireless data responsive to the lid moving from an open position to a closed position.

18. A method of operating a computer monitor, the method comprising:
receiving, using a data port on the computer monitor, display data from a host device via a cable coupled between the host device and the data port;
displaying the display data;
receiving, using the data port, wireless data from the host device via the cable concurrent with receiving the display data; and
transmitting, using a radio and an antenna on the computer monitor, the wireless data to a wireless access point.

19. The method of claim 18, further comprising:
generating, using the radio, wireless performance metric data associated with radio-frequency signals conveyed by the radio; and
transmitting, using the data port, the wireless performance metric data to the host device via the cable.

20. The method of claim 18, further comprising:
receiving, using the radio and the antenna, additional wireless data from the wireless access point, the additional wireless data having a destination address associated with the host device; and
transmitting, using the data port, the additional wireless data to the host device via the cable.
